(19) United States
(12) Patent Application Publication
(10) Pub. No.: US 2003/0038243 A1
(43) Pub. Date: Feb. 27, 2003

(54) Charged-particle-beam (CPB) optical systems, and CPB Microlithography systems comprising same, that cancel external magnetic fields

(75) Inventor: Atsushi Yamada, Yokohama city (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/209,752

(22) Filed: Jul. 31, 2002

(30) Foreign Application Priority Data
Aug. 23, 2001 (JP) 2001-252227

(51) Int. Cl. H01J 3/12

(52) U.S. Cl. 250/398; 250/492.2; 250/396 ML

(57) ABSTRACT

Charged-particle-beam (CPB) optical systems are disclosed in which external magnetic fields are effectively canceled. Such systems are especially suitable for use in CPB microlithography systems in which extreme isolation from external magnetic fields is required in each of the lens columns of the system. In an embodiment, four magnetic-field sensors are situated downstream of the substrate stage of the CPB microlithography system. The sensors are located in a plane perpendicular to the optical axis and situated equi-angularly relative to each other about the optical axis. Each sensor can be configured as, e.g., a Hall-effect sensor, a magnetic-resistance sensor, or a search coil (the latter for detecting AC magnetic fields). Most desirably, the sensors are incorporated into a single sensor capable of detecting magnetic fields in each of the X, Y, and Z directions. The sensors can be used in conjunction with an active-canceller.

### FIELD

This disclosure pertains to charged-particle-beam (CPB) optical systems (i.e., optical systems for use with one or more beams of electrons or ions rather than light), especially as used in CPB microlithography systems and methods. More specifically, the disclosure pertains to methods and devices for reducing penetration of external magnetic fields to a CPB optical system so as to reduce possible adverse effects of such external magnetic fields on the charged particle beam propagating through the system.

### BACKGROUND

Conventional charged-particle-beam (CPB) optical systems typically comprise assemblies of electromagnetic lenses, deflectors, and the like encased in one or more chambers (each termed a “column”). A column provides a suitable vacuum environment for the charged particle beam passing along an optical axis through the optical system. The column also provides some shielding of the charged particle beam from external magnetic fields (generated by, e.g., earth magnetism or external machinery) as the beam passes through the respective optical system. However, such shielding is not absolute and, especially for applications such as CPB microlithography, is usually inadequate. If an external magnetic field enters a column, the propagation trajectory of the charged particle beam can be bent or otherwise perturbed by the field, resulting in, for example, distortion of a pattern being lithographically projected by the beam.

To reduce incursion of external magnetic fields to the optical axis, many CPB optical systems include magnetic shielding associated with the outside and/or inside of the respective column(s). The shielding normally is made from a high-permeability material. In addition, a CPB microlithography system can be installed within a shielded room or other enclosure, in which magnetic shielding is incorporated into the walls of the room or enclosure. These various shielding approaches are termed “passive” shielding.

In addition to or alternatively to passive shields, so-called “active” shields can be used. Active shielding usually includes a magnetic-field detector situated inside or near the column. Whenever the detector senses an external magnetic field that has penetrated into the column, a countervailing magnetic field is produced by a magnetic-field-generating apparatus termed an “active canceller.” This generated field has magnitude and direction serving to cancel the external magnetic field that has penetrated into the column.

Some types of active cancellers are capable of generating a countervailing magnetic field oriented in any of the normal three dimensions in an X-Y-Z coordinate system. To such end, and for each axis, the active canceller comprises a respective pair of coils having a coil axis parallel to the respective axis (a total of six coils for achieving active cancellation in all three of the X, Y, and Z dimensions). By appropriately energizing the pairs of coils, the active canceller generates magnetic fields in the directions of each axis to produce a resultant field that cancels the target external field. By selectively energizing the three pairs of coils, a countervailing magnetic field can be generated in any direction.

In a CPB microlithography system intended to produce a pattern-transfer resolution of 100 nm or less, it currently is impossible to reduce a magnetic field, that has penetrated into a column of the system, to a suitably low magnitude using passive shields surrounding the column. This deficiency is due in part to the inevitable need for providing apertures and other disruptions in the shield, thereby forming pathways for external magnetic fields to enter the column. Even if the column were installed within a shielded room, the room would require one or more openings in the walls of the room, through which external magnetic fields could pass. Thus, achieving total shielding against external magnetic fields solely by this passive approach is impossible from a practical standpoint.

Hence, reducing the effect of external magnetic fields, on beam-trajectory and exposure events occurring inside a CPB microlithography column, to suitably low levels requires some type of active canceller in addition to passive shielding. However, use of an active canceller poses substantial issues regarding the locations at which detection of magnetic fields in the column should be performed, whether feedback should be employed, and the manner in which feedback should be employed. These issues are especially problematic in view of the extreme field-reduction requirements that must be met by the shielding scheme in order for the CPB microlithography system to exhibit the specified performance. For example, an ideal location for a magnetic-field sensor is on the optical axis of the CPB optical system, but this is impractical because the charged particle beam propagates along the optical axis. I.e., a sensor at such a location would interfere with propagation of the beam and thus render the system inoperable.

### SUMMARY

In view of the shortcomings of conventional methods and devices for preventing incursion of external magnetic fields into a column of a CPB optical system, the present invention provides, inter alia, improved devices and methods for achieving such magnetic shielding.

According to a first aspect of the invention, shielded CPB optical systems are provided. An embodiment of such a system comprises a column containing at least one CPB optical component situated relative to an optical axis parallel to a Z-axis in an X, Y, Z coordinate system. The system also includes an array of active-canceller coils situated relative to the column and configured, when energized, to generate a magnetic field. A first pair of magnetic-field sensors is arranged such that the sensors are situated at respective positions equidistant from the optical axis in an X-axis direction, and a second pair of magnetic-field sensors is arranged such that the sensors are situated at respective positions equidistant from the optical axis in a Y-axis direction. The magnetic-field sensors can be located inside or outside the column.

In this embodiment, the two magnetic-field sensors arranged in the X-axis direction, for example, allow determinations to be made of the mean magnitude of respective components of the external magnetic field in the X-axis direction, as well as the inclination of the field in the X-axis direction. These magnitude and inclination data can be used in controlling the electrical current delivered to the active-canceller coils. The coils, in turn, generate a countervailing magnetic field that effectively cancels the respective components of the external magnetic field in the X-axis direction, thereby achieving, at the optical axis, a substantially zero mean field having an X-direction inclination. Thus, the X-axis components of the external magnetic field are substantially reduced at the optical axis.

Similarly, the two magnetic-field sensors arranged in the Y-axis direction allow determinations to be made of the mean magnitude of respective components of the external magnetic field in the Y-axis direction, as well as the inclination of the field in the Y-axis direction. These magnitude and inclination data can be used in controlling the electrical current delivered to the active-canceller coils. The coils, in turn, generate a countervailing magnetic field that effectively cancels the inclination of the respective components of the external magnetic field in the Y-axis direction, thereby achieving, at the optical axis, a substantially zero mean field having a Y-direction inclination. Thus, the Y-axis components of the external magnetic field are substantially reduced at the optical axis.

By performing X-direction cancellation and Y-direction cancellation in this manner, the external magnetic field at the optical axis is nullified, with no significant components in either the X-direction or the Y-direction. Cancellation is especially simplified by configuring the active-canceller coils to generate a magnetic field any X-Y-Z direction in conjunction with the direction in which the sensors sense the magnetic field.

The shielded CPB optical systems summarized above can be used in CPB projection-microlithography systems that transfer a pattern from a reticle to a substrate, as well as in direct-writing type CPB microlithography systems.

In a CPB optical system as summarized above, the spacing between the first pair of magnetic-field sensors in the X-axis direction desirably is equal to the spacing between the second pair of magnetic-field sensors in the Y-axis direction. However, these spacings need not be equal. If they are not, it nevertheless is possible to control the electrical current delivered to the active-canceller coils in a manner that compensates for the unequal spacing. This control is based on data produced by the sensors, and results in elimination of the respective components of the external magnetic field in the directions of the respective axes, thereby achieving mean values of the external magnetic field at the optical axis that are as low as possible.

By making the spacings equal to each other, however, the respective currents delivered to the external coils can be based on similar outputs from all the sensors and adjusted so that the measured field by all the sensors is minimal at the same value. Thus, any otherwise possible need to repeatedly perform X-direction adjustments and Y-direction adjustments of the external magnetic field is eliminated, thereby simplifying operation.

Desirably, the magnetic-field sensors are situated relative to the optical axis at or near a coordinate on the Z-axis at which an external magnetic field would penetrate to the optical axis. Typically, the Z-axis coordinate corresponds to the location of a gap in a shield situated relative to the column. In many instances, the shield is made of the same material as the material forming the column. However, it is extremely difficult to provide shielding material at locations occupied by, for example, stages or other components that move relative to the column. Thus, these locations present gaps in the shield. The gaps provide less resistance to external magnetic fields directed toward the optical axis. By locating magnetic-field sensors at a gap Z-axis coordinate, the penetrating magnetic fields are more easily sensed and measured, and thus more completely canceled.

According to another aspect of the invention, CPB microlithography systems are provided that include a CPB optical system as summarized above. The CPB microlithography system can further comprise a substrate stage extending in an X-Y plane perpendicular to the optical axis. With such a configuration, the magnetic-field sensors can be situated in an X-Y plane parallel to the substrate stage but downstream of the substrate stage. I.e., downstream of the substrate stage is a region at which shielding typically is weaker or less effective. Consequently, an external magnetic field can concentrate in this region. By placing the magnetic-field sensors at this region, the external magnetic field directed toward the interior of the column is readily detected. In a typical CPB microlithography system, substantial design restrictions exist with respect to possible locations at which magnetic-field sensors can be accommodated. Fortunately, downstream of the substrate stage represents a location at which the sensors can be easily accommodated, thereby eliminating other design limitations imposed by locating the sensors elsewhere.

If the CPB microlithography system has an illumination-optical system (typically contained in a second column), then another location at which the sensors readily can be accommodated readily between the first and second columns. Also, if the microlithography system has a reticle stage, then the sensors can be accommodated readily between the reticle stage and the first column.

The foregoing and additional features and advantages of the invention will be more readily apparent from the following detailed description, which proceeds with reference to the accompanying drawings.

### BRIEF DESCRIPTION OF THE DRAWINGS

FIG. 1(a) is a schematic axial view of a first representative embodiment of a charged-particle-beam (CPB) optical system, in which four magnetic-field sensors are situated downstream of a substrate stage and downstream of a column.

FIG. 1(b) is an elevational view of the system shown in FIG. 1(a).

FIG. 2(a) is a schematic axial view of a second representative embodiment of a CPB optical system, in which four magnetic-field sensors are situated between first and second columns and downstream of a reticle stage.

FIG. 2(b) is an elevational view of the system shown in FIG. 2(a).

FIG. 3 is an oblique view showing an exemplary arrangement of active-canceller coils relative to first and second columns of a CPB optical system.

### DETAILED DESCRIPTION

The invention is discussed below in the context of representative embodiments that are not intended to be limiting in any way. Also, any reference below to an electron-beam optical system or microlithography system is not intended to be limiting because the general principles discussed below are applicable to use of other types of charged particle beams, such as ion beams, and to systems base on such alternative types of charged particle beams.

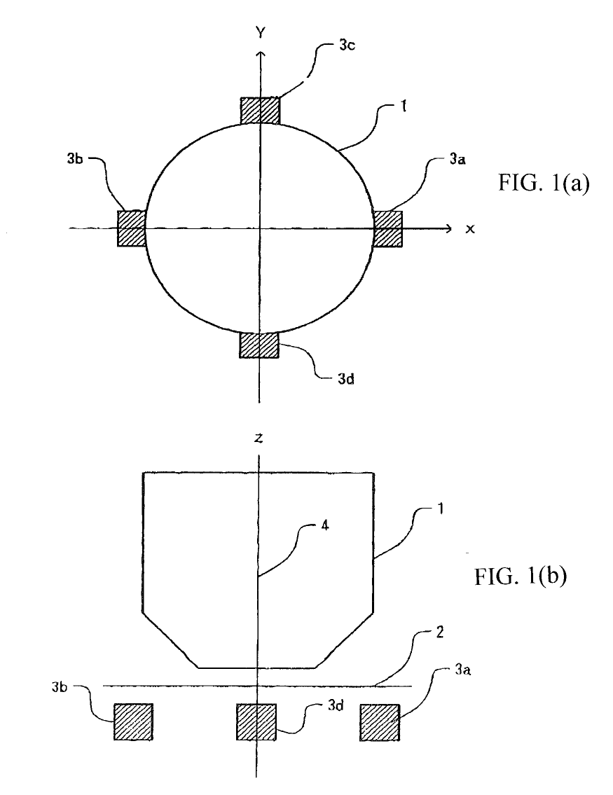

A first representative embodiment is schematically depicted in FIGS. 1(a)-1(b), wherein FIG. 1(a) is an axial view and FIG. 1(b) is an elevational view. In the figures, a column 1 of a projection-optical system of an electron-beam optical system is shown. The column 1 is centered on an optical axis 4. The optical axis 4 is parallel to the Z-axis of the depicted system. Situated downstream of the column 1 is a substrate stage 2 that extends perpendicularly to the axis 4. Although not shown in the figure, it will be understood from the context of an electron-beam microlithography system that illumination of a reticle (defining a pattern to be projection-transferred onto the substrate 2) occurs by an illumination-optical system encased in a respective column situated upstream of the column 1. During microlithography being performed with the depicted system, a pattern defined on the reticle is illuminated by the illumination-optical system, and an image of the illuminated pattern is projected onto the substrate by the projection-optical system. This projection of the image requires lens actions and beam-deflection actions that require the generation and utilization of magnetic fields inside the column(s).

In this embodiment, four magnetic-field sensors 3a, 3b, 3c, 3d are disposed just downstream of the substrate stage 2. Considering the optical axis 4 as the Z-axis in an X-Y-Z rectangular coordinate system, magnetic-field sensors 3a and 3b are arranged on the X-axis at positions equidistant from the optical axis 4. In addition, magnetic-field sensors 3c and 3d are arranged on the Y-axis at positions equidistant from the optical axis 4. The magnetic-field sensors 3a-3d can have any of various configurations, such as Hall-effect devices and magnetic-resistance elements. Search coils alternatively can be used if measurements only of AC magnetic fields are desired. Desirably, the magnetic-field sensors 3a-3d are respective portions of a single type of magnetic-field sensor configured to detect magnetic fields in all three dimensions, namely the X, Y, and Z dimensions.

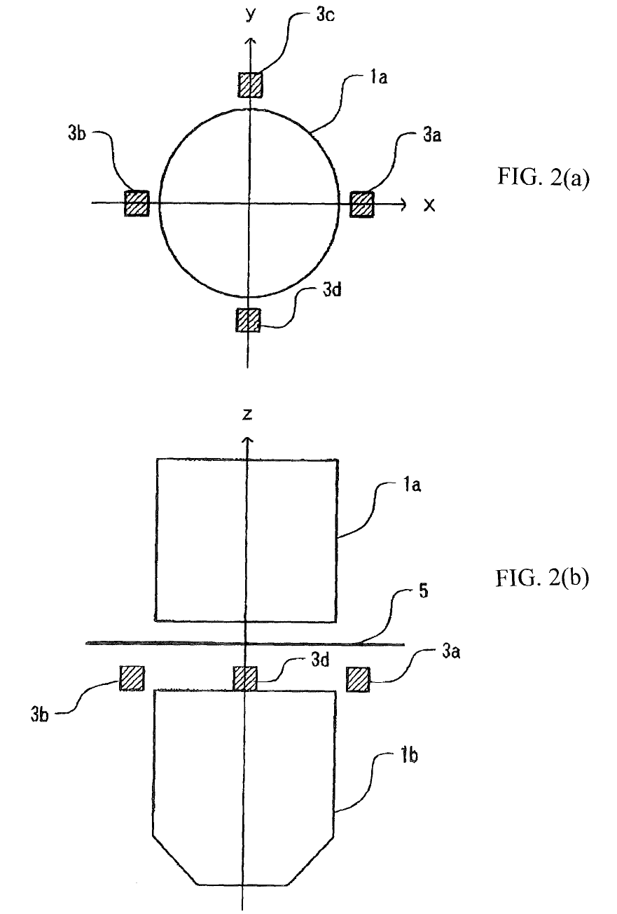

A second representative embodiment is shown in FIGS. 2(a)-2(b), which depicts four magnetic-field sensors 3a, 3b, 3c, 3d arranged equi-angularly around the Z-axis (optical axis) between a “lower” (downstream) column 1b housing a projection-optical system and an “upper” (upstream) column 1a housing an illumination-optical system. More specifically, the magnetic-field sensors 3a-3d are situated in this embodiment between the reticle stage 5 and the lower column 1b. The reticle stage 5 is configured to hold and move a pattern-defining reticle mainly in the X and Y directions. This movement must occur between the illumination-optical system and the projection-optical system; hence, the reticle stage 5 occupies a space between the columns 1a and 1b. From this space, external magnetic fields can enter either or both the columns 1a, 1b and fluctuate the magnetic field on the optical axis.

In this embodiment, four magnetic-field sensors 3a, 3b, 3c, 3d are provided downstream of the reticle stage 5 within the space between the columns 1a, 1b. Relative to the Z-axis in an X-Y-Z rectangular coordinate system, two magneticfield sensors 3a and 3b are situated on the X-axis equidistantly from the Z-axis. Similarly, two magnetic-field sensors 3c and 3d are situated on the Y-axis equidistantly from the Z-axis. The types and performance characteristics of the magnetic-field sensors in this embodiment can be similar to the magnetic-field sensors used in the first representative embodiment.

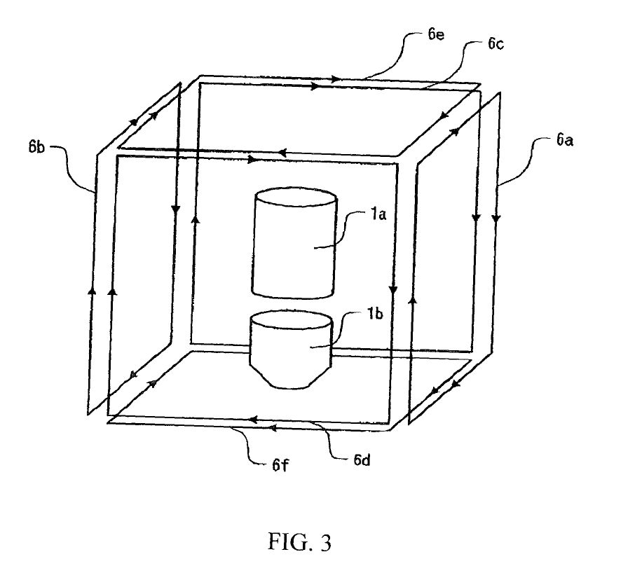

An exemplary relationship between the columns 1a, 1b of the second representative embodiment is shown in FIG. 3, which also depicts the relationship between the columns 1a, 1b with coils 6a-6f of a surrounding active canceller. The coils 6a, 6b are wound perpendicularly to the X-axis, the coils 6c, 6d are wound perpendicularly to the Y-axis, and the coils 6e, 6f are wound perpendicularly to the Z-axis. When energized, the coils 6a and 6b, 6c and 6d, and 6e and 6f generate respective magnetic fields in the X-axis, Y-axis, and Z-axis directions.

Using the configuration of the second representative embodiment described above, and in the context of an electron-beam microlithography system, cancellation of magnetic fields penetrating to the interior of a lens column is performed as follows. First, the respective excitation currents delivered to the various lenses and deflectors of the lens columns 1a, 1b are turned off. In this off condition, the outputs of each of the magnetic-field sensors 3a, 3b are obtained. The respective electric currents flowing to the cancellation coils 6a-6f are adjusted as required until the respective magnetic fields detected by the sensors 3a, 3b are equal in magnitude and direction, thereby minimizing the difference between the fields.

Next, the outputs of the magnetic-field sensors 3c, 3d are obtained. The respective electric currents flowing to the cancellation coils 6a-6f are adjusted as required until the respective magnetic fields detected by the sensors 3c, 3d are equal in magnitude and direction, thereby minimizing the difference between the fields. These field measurements and coil adjustments are repeated as required to produce substantially no difference in output between respective paired magnetic-field sensors, with their respective outputs being as low as possible. Thus, external magnetic fields at the optical axis, where penetrating external magnetic fields otherwise could be a problem, are reduced substantially to zero in magnitude and direction.

The magnetic-field sensors 3a-3d typically are connected to a processor (not shown but well understood in the art) configured to process data from the magnetic-field sensors and to control operation of the coils 6a-6f in a feedback manner based on the processed data.

In general, the Z-direction position of the X-Y plane where the four magnetic-field sensors are located desirably is a location at which external magnetic fields entering the system tend to be large and/or tend to have a relatively large effect. Also, the position should be capable of physically accommodating the magnetic-field sensors without interfering with the beam trajectory or with operation of stages or other components.

Whereas the invention has been described in connection with representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed:

1. A shielded charged-particle-beam (CPB) optical system, comprising:
a column containing at least one CPB optical component situated relative to an optical axis parallel to a Z-axis in an X, Y, Z coordinate system;
an array of active-canceller coils situated relative to the column and configured, when energized, to generate a magnetic field;
a first pair of magnetic-field sensors arranged such that the magnetic-field sensors are situated at respective positions equidistant from the optical axis in an X-axis direction; and
a second pair of magnetic-field sensors arranged such that the magnetic-field sensors are situated at respective positions equidistant from the optical axis in a Y-axis direction.

2. The CPB optical system of claim 1, wherein a spacing between the first pair of magnetic-field sensors in the X-axis direction is equal to the spacing between the second pair of magnetic-field sensors in the Y-axis direction.

3. The CPB optical system of claim 1, wherein the first and second pair of magnetic-field sensors are situated relative to the optical axis at a coordinate on the Z-axis at which an external magnetic field otherwise would penetrate to the optical axis.

4. The CPB optical system of claim 3, wherein the coordinate on the Z-axis corresponds to a gap in a shield situated relative to the column.

5. The CPB optical system of claim 1, wherein the magnetic-field sensors are configured to provide magnetic-field data used for controlling energization of the active-canceller coils sufficiently to cause the active-canceller coils to cancel the external magnetic field at the optical axis.

6. A CPB microlithography system, comprising the CPB optical system of claim 1.

7. A charged-particle-beam (CPB) microlithography system, comprising:
a column containing one or more components, selected from the group consisting of lenses and deflectors, arranged on an optical axis and configured to direct a charged particle beam toward a lithographic substrate in a manner by which a pattern is transferred by the beam to the substrate;
an array of active-canceller coils situated relative to the column and configured, when energized, to generate a magnetic field;
a first pair of magnetic-field sensors arranged such that the magnetic-field sensors are situated at respective positions equidistant from the optical axis in an X-axis direction; and
a second pair of magnetic-field sensors arranged such that the magnetic-field sensors are situated at respective positions equidistant from the optical axis in a Y-axis direction.

8. The system of claim 7, further comprising a substrate stage extending in an X-Y plane perpendicular to the optical axis, wherein the magnetic-field sensors are situated in an X-Y plane parallel to the substrate stage but downstream of the substrate stage.

9. The system of claim 8, wherein:
the column contains a projection-optical system; and
the magnetic-field sensors are situated in an X-Y plane downstream of the substrate stage and the column.

10. The system of claim 7, wherein the first and second pair of magnetic-field sensors are situated relative to the optical axis as a coordinate on the Z-axis at which an external magnetic field otherwise would penetrate to the optical axis.

11. The system of claim 7, wherein:
the column is a first column of the system, containing a projection-optical system;
the system further comprises a second column situated relative to the optical axis upstream of the first column;
the second column contains an illumination-optical system; and
the magnetic-field sensors are situated in an X-Y plane between the first and second columns.

12. The system of claim 11, further comprising a reticle stage situated between the first and second columns, wherein the magnetic-field sensors are situated in an X-Y plane downstream of the reticle stage but upstream of the first column.

13. The system of claim 7, wherein the active-canceller coils surround the CPB microlithography system.

14. The CPB microlithography system of claim 7, wherein the magneticfield sensors are configured to provide magnetic-field data used for controlling energization of the active-canceller coils sufficiently to cause the active-canceller coils to cancel the external magnetic field at the optical axis.

15. In a method for directing a charged particle beam through a charged-particle-beam (CPB) optical system including a column containing at least one CPB optical component situated relative to an optical axis parallel to a Z-axis in an X, Y, Z coordinate system, a method for reducing an external magnetic field from extending to the optical axis, the method comprising:
providing an array of active-canceller coils situated relative to the column and configured, when energized, to generate a magnetic field;
arranging a first pair of magnetic-field sensors at respective positions equidistant from the optical axis in an X-axis direction;
arranging a second pair of magnetic-field sensors at respective positions equidistant from the optical axis in a Y-axis direction; and
based on magnetic-field data obtained by the magnetic-field sensors, energizing the active-canceller coils so as to cancel the external magnetic field at the optical axis.

16. In a method for performing charged-particle-beam microlithography, in which a charged particle beam is directed through a charged-particle-beam (CPB) optical system including a column containing at least one CPB optical component situated relative to an optical axis parallel to a Z-axis in an X, Y, Z coordinate system, a method for reducing an external magnetic field from extending to the optical axis, the method comprising:
providing an array of active-canceller coils situated relative to the column and configured, when energized, to generate a magnetic field;
arranging a first pair of magnetic-field sensors at respective positions equidistant from the optical axis in an X-axis direction;
arranging a second pair of magnetic-field sensors at respective positions equidistant from the optical axis in a Y-axis direction; and
based on magnetic-field data obtained by the magnetic-field sensors, energizing the active-canceller coils so as to cancel the external magnetic field at the optical axis.
